(19) United States
(12) Patent Application Publication
(10) Pub. No.: US 2011/0296462 A1
(43) Pub. Date: Dec. 1, 2011

(54) APPARATUS, SYSTEM AND METHOD FOR DISPLAYING IMAGES ONTO A SCREEN

(75) Inventors: Giorgio Mendella, Viareggio (IT); Marzena Karczewska, Viareggio (IT)

(73) Assignee: GHOST TECHNOLOGY INC., Aventura, FL (US)

(21) Appl. No.: 13/125,197

(22) PCT Filed: Oct. 22, 2008
(86) PCT No.: PCT/IB2008/002823

§ 371 Date: Aug. 15, 2011

(30) Foreign Application Priority Data
Oct. 23, 2007 (IT) BO2007A000708

(51) Int. Cl. H04N 21/431

(52) U.S. Cl. 725/40

(57) ABSTRACT

The disclosure relates to an apparatus, a system and a method for displaying images onto a screen. The apparatus can be used to display images onto the screen for displaying programmes and/or messages and/or additional images which temporarily replace and/or are combined with programmes and/or messages and/or main images which are generally reproduced onto the screen that is to say received by any signal transmission device and selected by the television set by a television tuner.

The invention relates to and apparatus, a system and a method for displaying images onto the screen.

In particular, the invention relates to an apparatus and a method which, besides the display of conventional television programmes (using this term for programmes and/or images and sounds from sources which are external to a television set such as DVDs, cameras, videocameras, satellite and/or digital decoders, cable broadcasting stations and so on) allow the display of other different programmes and/or messages and images from “remote hosts” onto the same screen as said display does not depend on the choice of a given channel and/or signal source and does not hinder the free and completely intelligible vision of a television channel or of what is spread by other sources. The display of the above programmes from “remote hosts” will be regulated by agreements between the television set or monitor user and the supplier.

The invention allows the host to detect in real time the main actions of the spectator on his television set and /or monitor and to detect the permanence time of the spectator on each channel and/or programme or source for statistical purposes. To conclude, the invention allows the spectator to interact with third persons through “the host” and to send answers, opinions, preferences, choices of any type by means of the remote control television switch and to buy, book or order by using said equipment. All these operations, except the options described in one of the above features (that is to say sending choices and preferences) can be carried out with no need for the spectator to send commands to his/her TV set so that he/she simply controls the usual functions with no limits (such as changing the channel, modifying the volume and luminosity or other parameters that the user generally controls).

Some of the known apparatus are intended to display images onto the TV screen. The use and functionality of said apparatus are extremely limited and this is due to different causes, as described below.

For some solutions, it is necessary to use a “PC video card” in addition to a conventional TV tuner because, if said PC video card were not used, the remote host would not recognize the channel on which the user's television is positioned at a given moment, so the host would not be capable of remotely intervening on the video to insert images: in fact, these images would be displayed just when the host is displaying a programme even if the spectator would like to watch said programme undisturbed. In practice, it would be impossible to know when an advertising programme starts on a given channel while the spectator is watching it at a given moment from a “remote” host.

In order to overcome the above inconvenience, a “video card” is added to the conventional TV tuning system; in this way, the host can know the parameters of a real television display. In some cases, the video card is implemented in external equipment which the user connects to the television set (DVDs or decoders) but, in these cases, the output signals of said equipment can be displayed by the user only if the TV set is tuned to corresponding outputs. In practice, said equipments are completely unusable either for interaction with the television set (if the same TV set is not used on the specific input to which it is connected) or for detecting the television activities and for their transmission to a remote host. The use of a “video card” leads to a series of disadvantages that negatively affect the apparatus. A first inconvenience relates to the quality of the video image processed by a PC video card because an image, which is reproduced on a TV screen, is quantitatively inferior to the image of a TV tuning system; besides, the display speed is inevitably slowed down (as the video card digitalizes images which need to be de-digitalized to be displayed onto a normal television system); another inconvenience is due to the fact that the control of the system is slower and much more complex as it is necessary to use two remote control TV switches (a remote control TV switch for the PC system which controls the video card and the remote control TV switch for the television set) and this may cause the user to make control errors.

Without using a video card it is impossible to send signals to the spectator's TV set because, as previously said, it is impossible to know which channel has just been displayed. In this case, the host can send a generic signal to the user's television set (just like in case of a warning of the presence of messages in some types of decoders or satellite and digital controllers) and the user has to position his/her television onto a given channel or digit a specific command to display all the images that have just been sent. Moreover, in order to display said images, the television set needs to be positioned on a specific source (for example a digital or satellite decoder) that has sent the message (in particular, if the user is watching a terrestrial channel and is not tuned in the decoder, he will not know that the decoder controller has just him/her a message). Moreover, the decoder controller will not know how the user utilizes the television set unless the user is positioned on a given input which is relative to the decoder.

Other systems do not allow the host to interact with the user's TV set in an stable and independent manner despite agreements between the user and the supplier; for example, from a “remote mode”, it is not possible to change a channel in which the television is tuned, to do this, each time the user needs to programme a further piece of equipment positioned in close vicinity to the television set itself so that it may partially modify the status of the television set according to the programming that has been carried out by the user.

Also this system leads to remarkable practical limitations. Moreover, some apparatuses are capable of sending either to an acoustic signaller (buzzer) or to a displayer (in addition to the television video integrated in a further equipment) signals such as “a beep” or a “message” but said apparatuses do not have a practical usefulness which is advantageous for the spectator because, in these cases, the spectator may divert his/her attention away from the programme he/she is watching. Besides, also in this case, inconveniences may arise due to the absence of detection of the channel which is being displayed.

The aim of the present invention is to overcome the above inconveniences.

This result was reached in accordance with the invention, by adopting the idea of providing an apparatus, a system and a method having the features described in the independent claims.

Other features are described in the dependent claims. Some of the advantages of the present invention are described below.

Thanks to the apparatus, the system and the method of the present invention, it is possible to display images onto a screen so that the screen user can interact with a remote host, not considering what he/she intends to display; thanks to the invention, it is possible to display images onto the screen by means of the apparatus and to enable the remote host to know the functions the apparatus is intended to carry out on user request, no matter what display choices the user makes; besides, the user can send and receive telephone messages (usually called SMS or MMS) and display their texts onto the apparatus video; the user can write or send said messages by means of the remote control television switch. The invention allows the user to request specific information from the Internet network or to access specific network sites by means of the remote control television switch without using further equipment or typing in particular requests. Moreover, it allows the display of the above images with or without audio accompanying and said images can be video films or messages, presentations of possible answers to choose, trade marks, slogans, writings, slides and so on.

Every technician who work in this field will better understand these advantages and further advantages and features of the present invention thanks to the following description and to the enclosed drawings as a practical exemplification of the invention which should not be considered in a limitative sense, wherein:

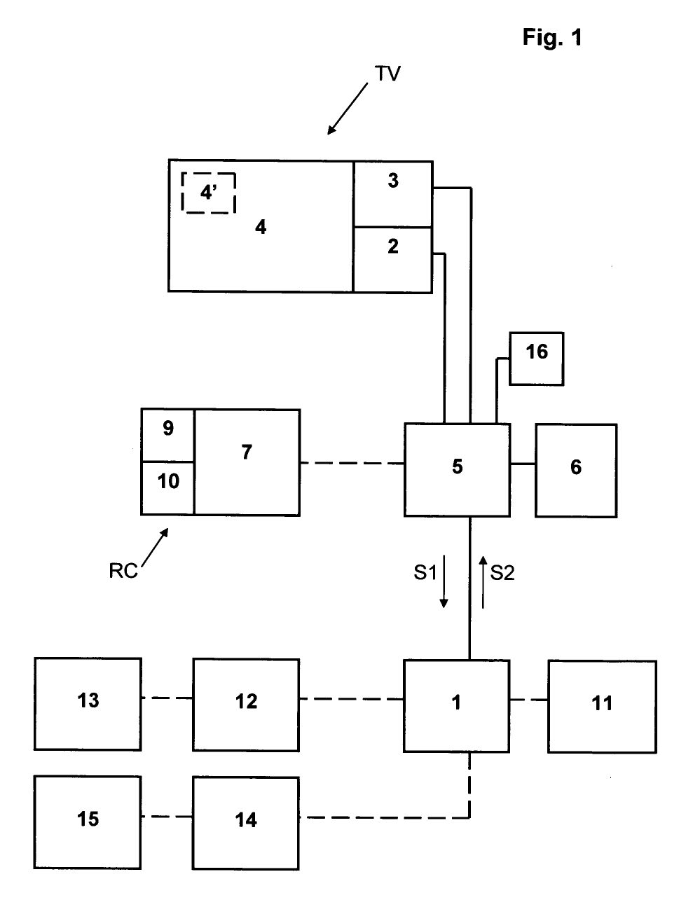

FIG. 1 is a block diagram relative to a possible non-limitative embodiment of the present invention.

With reference to the enclosed drawings, which show a schematic, non-limitative representation, the invention relates to an apparatus for displaying images onto a screen (4) which can be used to display images onto the screen (4), to display programmes and/or messages and/or additional images which temporarily replace and/or are combined with programmes and/or messages and/or main images which are generally reproduced onto the screen (4), that is to say received by any signal transmission means and selected by the television set by means of a television tuner (2).

The apparatus of the present invention comprises a local processing unit (5) which detects the tuner protocols (2) to verify the configuration assumed by the television set, that is the relative instantaneous tuning of the TV set itself in order to send corresponding signals (S1) to a remote unit (1) connected to the local unit (5) by means of a bi-directional signal transmission channel.

On the basis of the signals received from the local unit (5), the remote unit (1) sends second signals (S2) to the local unit itself so as to command the beginning and the end of the display of programmes and/or messages and/or additional images onto the screen (4). In the following description, the term “additional programmes” instead of the term “additional programmes and/or messages and images” will often be used.

In FIG. 1, diagram (3) indicates the television or monitor video card provided with the apparatus subject of the present invention.

Advantageously, the local unit (5) can be provided with storage means (6) which are accessible and programmable at a distance from said remote control unit (1). In other words, from remote mode, it is possible to vary the type and duration of additional programmes to be displayed.

The remote control unit (1) is connected to a fixed or mobile telephone network (11) supported by a system for vehiculating messages. The remote control unit (1) is inserted and can be identified on the network (11) by means of a telephone number. A software programme is present in the remote control unit (1) that is to say said software programme unit (1) is connected to it; when a message has been received by the remote control unit, the software programme sends the message received from the network to the local unit (5) according to an identification code of the local unit itself (5) and said code is coupled with the message sent. The local unit (5) will display the message onto the screen (4). With reference to the enclosed drawings, a remote control television switch (RC) is connected to the local unit (5) and provided with a keyboard (7) which can be used for typing in messages.

The remote control unit (1) is connected to the Internet network (14) so as to allow a bi-directional connection to the local unit. In particular, the Internet connection (14) can be provided with storage means for a number of preferred pages (15) that is of sites frequently utilized by the user so that the user can have immediate access to said sites through an abbreviated choice.

Moreover, the Internet connection (14) can be enabled to a voice transmission service through Internet protocol (for example VoIP); the remote control television switch (RC) being provided with a keyboard (7) with an earphone (9) and with a microphone (10) for this purpose.

The apparatus can be provided with a GPS portable detecting device (13) inserted in a GPS localization network (12) which is connected to the remote control unit (1); in this way, it is possible to send a signal relative to the positioning of the portable device (13) to the local unit (5). Moreover, the localization network (12) and/or said remote control unit (1) can be provided with an archive of maps that can be used by the remote control unit (1) to send one or more images to the local unit (5) in which the positioning of the GPS portable device (13) is highlighted on the corresponding map. In practice, said portable device can be delivered to a third person, and this person may not be the spectator (for example it may be one of the spectator's relatives) and this device allows the operator to know where this person is.

The display of additional programmes can take place on the whole television or monitor screen or on one portion of said screen. In particular, said television set or monitor are provided with partial display means that is the “pip type” (picture in picture), so additional programmes can be displayed into one or more windows having predetermined sizes being said programmes and/or messages additional images.

The remote control unit (1) can advantageously be provided with data storage means which collect or select signals (S1) received from the local unit (5) which are relative to the tuner (2) protocol to detect the operations the spectator is carrying out on the television set or on the monitor to which the apparatus is connected. In this way, it is possible to carry out statistical studies on the real use of the television set and to know in real time in which channel the television set is tuned, the value of the volume that has been used, and so on. In other words, in case of previous agreements between the manager and the user, it is possible to totally control all the operations that have been effected.

The apparatus described above can be connected to a television set or to a monitor or integrated in them. In this case, the television set or the monitor will have the features described above.

A plurality of apparatuses comprising local units (5), which are connected to a remote control unit by means of a telematic network, form a system realised according to the present invention.

According to the invention, the method consists in: locally detecting the tuner protocols (2) in order to verify the configuration assumed by the television set, that is to say the relative instantaneous tuning of the television set itself; sending corresponding signals (S1) to a remote control unit (1) from a local unit (5) by means of a bi-directional signal transmission channel; sending second signals (S2) from the remote control unit (1), on the basis of signals received from the local unit (5), second signals (S2) to the local unit (5) in order to command the beginning and the end of the display of said programmes and/or messages and/or additional images onto said screen (4).

Advantageously, the method can comprises the storing in the local unit (5) of additional programmes that can be modified from remote.

The method can comprise: connecting the remote control unit (1) to a fixed or mobile telephone network (11) which supports a system for conveying messages; identifying the remote control unit (1) on the network (11) by means of a telephone number; sending a message received from the network to a local unit (5) according to an identification code of the local unit itself (5) which is coupled with the message by the message sender; displaying the message received by the local unit (5) on the screen (4). It is possible to use a remote control television switch (RC) connected to the local unit (5) for typing in messages.

According to the method, the remote control unit (1) is connected to the Internet network (14) in order to allow a bidirectional connection to the local unit and to store a given number of preferred pages (15) that is to say of sites which are frequently used by the user so that the user can immediately connect to these sites through an abbreviated choice.

The method can also foresee an Internet connection (14) by enabling a voice transmission service through Internet protocol and the local unit (5) can be equipped with a remote control switch (RC) provided with a keyboard (7), with an earphone (9) and with a microphone (10), which can be used to telephone.

It is also possible to use a portable detection GPS device (13) inserted in a corresponding GPS localization network (12) connected to the remote control unit (1) to send a signal relative to the positioning of the portable device to the local unit (5). Moreover, it is possible to use an archive of maps to send one or more images to the local unit in which the positioning of the GPS portable device is highlighted on the corresponding map.

Advantageously, the method can foresee the use of a television set or of a monitor provided with partial display means that is to say the Pip type, “picture in picture” in order to display said programmes or additional images onto windows having predetermined sizes.

Moreover, it is possible to store the collection and/or selection of the signals (Si) received from said local unit (5) which are relative to the tuner protocols (2) which detect the operations the spectator is carrying out on the television set or on the monitor to which the apparatus is connected.

In practice, to sum up the innovative features of the present invention, the apparatus integrated in the television set (or connected to it) reads the “ protocols” of the television set tuner and informs the host (unit 1) about the position of the television set so that the host can detect “what the television set is doing” and send video signals and/or messages without interfering with the user's vision of the programmes. This function allows for cost savings in the production (as it is not necessary to add a further video card and/or tuner card) and the video signal quality and speed remain absolutely unaltered (the video signal remains the usual signal of the television set).

Moreover, a special software allows the reception of messages such as SMS or MMS messages and their transmission by typing in the number and the text by means of the remote control switch. As previously said, the messages that have just arrived are sent by the sender to a (telephone) number which indicates the host and to which the sender adds a “code” which refers to the receiver (that is to say the local unit 5 of its equipment or IP). The host database recognizes the IP (or local unit 5 with reference to the drawings) to which the “code” refers and sends the text of the message to the television set connected to said IP. Similarly, when the user wants to transmit a message, he/she will have to type in the number of the receiver only, the message is set by the host automatically to the requested number.

Moreover, the apparatus allows the use of the normal “PIP” of the television set as a new, further television set onto which it is possible to send films, messages, notices, ads, television programmes and so on. This is possible since the frame storage of the television set influenced by the PIP is connected both to the internal hard disk (6) and to the modem section that is to say to the connecting section of the local unit (5), and, if the remote mode sends an order, it is capable of displaying massages sent in “real time” by the remote host and to start the display of films which are resident in the hard disk (updatable by remote). Said PIP frame storage can have various sizes: for example, it can be a “half-screen storage” or a “one-eighth-of-screen-storage”; this happens when the programme that the user is watching is re-proportioned without damaging the reproduction of the programme both in its vision and in its listening. The window displayed by means of the “PIP” can be positioned at any angle of the television set.

Moreover, thanks to the Internet connection and, through the Internet connection itself, thanks to the connection to a GPS detecting device, by equipping a third element with said GPS portable detecting device (13) it is possible to detect its position directly on the television set by inserting into it various maps that the user may find interesting.

Besides, the television set is equipped with additional inputs, for example one or more USB ports (16) which allow the user to download data into it (that is to say files containing pictures, films, audio files and so on) so that he/she can store them into the television hard disk (6) and display them when wished (it is also possible to delete them).

As the television set is constantly connected to the Internet, the user can utilize a series of pre-stored utility pages (15) such as the weather forecast, television news, his/her own bank account, his/her bills and anything else he/she needs. The programming takes place from remote mode, according to the user's indications.

The television set is constantly connected to the Internet thanks to the IP voice technology and, through the remote control switch, it can be used as a telephone; the audio part of the telephone, “that is the “microphone and the loudspeaker” can be implemented directly into the remote control switch.

To conclude, thanks to the present invention, it is possible for the spectator to interact with third parties through the host and to send answers, opinions, preferences and any types of choices by using the television remote control switch as well as to buy, to book and to order by using said apparatus.

The control devices of the elements described above, which are shown in the enclosed drawings, are known to the technicians who work in this field and, for this, reason, they have not been described in detail in order to simplify their explanation. Moreover, the execution details may vary as regards the shape the size, the arrangement of the elements, the kind of material used, but they are within the limits of the solution adopted and within the limits of the protection offered by the present patent.

1. Apparatus for displaying images onto a screen which can be used to display images onto the screen for displaying additional programmes and/or messages and/or images which temporarily replace and/or are combined with programmes and/or messages and/or main images which are generally reproduced onto the screen, that is to say received by any signal transmission means and selected by the television set by means of a television tuner, apparatus comprising a local processing unit which detects the tuner protocols to verify the configuration assumed by the television set, that is the relative instantaneous tuning of the TV set itself, in order to send corresponding signals to a remote unit, connected to the local unit by means of a bi-directional signal transmission channel; and in that said remote unit, on the basis of the signals received from the local unit, sends second signals to the local unit itself for commanding the beginning and the end of the display of additional programmes and/or messages and/or images onto the screen.

2. Apparatus according to claim 1, wherein said local unit is provided with storage means for said additional programs and/or messages and/or images, said storage means being accessible and programmable at a distance from said remote control unit.

3. Apparatus according to claim 1, wherein said remote control unit is connected to a fixed or mobile telephone network, supporting a system for vehiculating messages, in that said remote control unit is inserted and can be identified on the network by means of a telephone number; and in that in said remote control unit or connected to the same, there is a software programme which, when a message has been received by said remote control unit, sends the message received from the network to the local unit, according to an identification code of the local unit itself which is coupled with the message by the sender said local unit displaying the message onto the screen screen.

4. Apparatus according to claim 3, wherein it is provided with a remote control television switch connected to the local unit and provided with a keyboard which can be used for typing in messages.

5. Apparatus according to claim 1, wherein said remote control unit is connected to the Internet network so as to allow a bi-directional connection to the local unit.

6. Apparatus according to claim 5, wherein the Internet connection can be provided with storage means for a number of preferred pages, that is of sites frequently utilized by the user, so that the user can have immediate access to said sites through an abbreviated choice.

7. Apparatus according to claim 5, wherein the Internet connection is enabled to a voice transmission service through Internet and that said apparatus is provided with a remote control television switch provided with a keyboard with an earphone and with a microphone.

8. Apparatus according to claim 1, wherein it is provided with a GPS portable detecting device inserted in a GPS localization network which is connected to the remote control unit in order to send a signal relative to the positioning of the portable device to the local unit.

9. Apparatus according to claim 8, wherein said localization network and/or said remote control unit are provided with an archive of maps that can be used by the remote control unit to send one or more images to the local unit in which the positioning of the GPS portable device is highlighted on the corresponding map.

10. Apparatus according to claim 1, wherein said television set or monitor connected to the apparatus are provided with partial display means, that is the “PiP type—picture in picture”, so additional programmes are displayed into one or more windows having predetermined sizes being said programmes and/or messages additional images.

11. Apparatus according to claim 1, wherein said remote control unit is provided with data storage means which collect and/or select received from the local unit, relevant to the tuner protocol, for detecting the operations the spectator is carrying out on the television set or on the monitor to which the apparatus is connected.

12. Apparatus according to claim 1, wherein the apparatus is integrated with a television set or with a monitor.

13. System for displaying images onto a screen, wherein it is formed by a plurality of apparatuses comprising local units according to claim 1, connected to a remote control unit by means of a telematic network.

14. Method for displaying images onto a screen usable for displaying additional programmes and/or messages and/or images which temporarily replace and/or are combined with programmes and/or messages and/or main images which are generally reproduced onto the screen that is to say received by any signal transmission means and selected by the television set by means of a television tuner, method comprising:
locally detecting the tuner protocols in order to verify the configuration assumed by the television set, that is to say the relative instantaneous tuning of the television set itself;
sending corresponding signals to a remote control unit from a local unit by means of a bi-directional signal transmission channel;
sending second signals from the remote control unit, on the basis of signals received from the local unit, second signals to the local unit in order to command the beginning and the end of the display of said additional programmes and/or messages and/or images onto said screen.

15. Method according to claim 14, comprising the storing in the local unit of said additional programmes and/or messages and/or images.

16. Method according to claim 15, wherein modifying from remote said additional programmes and/or messages and/or images.

17. Method according to claim 14, comprising:
connecting said remote control unit to a fixed or mobile telephone network which supports a system for conveying messages;
identifying the remote control unit on the network by means of a telephone number;
sending a message received from the network to a local unit according to an identification code of the local unit itself which is coupled with the message by the message sender;
displaying the message received by said local unit on said screen.

18. Method according to claim 17, comprising using a remote control television switch connected to the local unit for typing in messages.

19. Method according to claim 14, comprising connecting said remote control unit to the Internet network in order to allow a bidirectional connection to said local unit.

20. Method according to claim 19 comprising storing a given number of preferred pages, that is to say of sites which are frequently used by the user, so that the user can immediately connect to these sites through an abbreviated choice.

21. Method according to claim 19 comprising:
connecting to Internet by enabling a voice transmission service through Internet protocol;
providing said local unit can with a remote control switch provided with a keyboard, with an earphone and with a microphone which can be used to telephone.

22. Method according to claim 19 comprising using a portable detection GPS device inserted in a corresponding GPS localization network, connected to the remote control unit to send a signal relative to the positioning of the portable device to the local unit.

23. Method according to claim 22 comprising using an archive of maps to send one or more images to the local unit in which the positioning of the GPS portable device is highlighted on the corresponding map.

24. Method according to claim 14 comprising using a television set or of a monitor provided with partial display means that is to say the PiP type, “picture in picture” in order to display said programmes or additional images onto windows having predetermined sizes.

25. Method according to claim 14 comprising storing and/or selecting the signals received from said local unit relevant to the tuner protocols for detecting the operations the spectator is carrying out on the television set or on the monitor to which the apparatus is connected.
